(19) United States
(12) Patent Application Publication
(10) Pub. No.: US 2006/0106768 A1
(43) Pub. Date: May 18, 2006

(54) Method and website for making travel plans

(75) Inventor: Marc van Deursen, Den Bosch (NL)

Correspondence Address: GREER, BURNS & CRAIN, 300 S WACKER DR, 25TH FLOOR, CHICAGO, IL, 60606, US

(73) Assignee: A W Seabiscuit B.V.

(21) Appl. No.: 10/987,673

(22) Filed: Nov. 12, 2004

(51) Int. Cl. G06F 17/30

(52) U.S. Cl. 707/3

(57) ABSTRACT

Embodiments of the present invention generally relate to a method and a website for making travel plans between an originating location and a destination that may be at least partially determined by weather criteria that may exist at the destination during the time period in which a trip is to be made.

### BACKGROUND OF THE INVENTION

The present invention generally relates to a method and website for making travel plans.

The travel industry has utilized computerized reservations systems (CRS) to access airline and rail schedules as well as book flights and other reservations that are travel related. These systems usually have certain databases and functionality that can only be used by subscribing travel agencies, but also provide similar but less extensive capabilities that can be used by individuals to plan as well as book travel arrangements for business and pleasure. There are many computerized reservation systems that are used worldwide and include systems that operate under the brands of Galileo, Amadeus, Sabre and Worldspan. These systems are predominantly used by travel agents and the industry and are used to book airline travel as well as other types of travel to a lesser extent, throughout the world. When travel arrangements are to be made, the traveler can directly access a website such as Orbitz, Travelocity, and others for the purpose of determining what flights are available at what time and date, and at what price. Alternatively, such information can be obtained from a travel agent who generally performs the same tasks. However, travel agents as well as others in the industry have databases and powerful search tools available to them that are not available to an individual traveler who attempts to make arrangements through the websites that are available to them.

Regardless of the databases that are typically accessed, all known systems uniformly operate on the basis that a traveler or operator inputs the originating location as well as the destination, the departure date as well as the return date and searches for available flights. The results of the search usually reveal the available flights (including nonstop or multiple stop flights) and their cost. If a selection is made, other important data such as the number of travelers, the class of ticket they wish to purchase, seat and meal options and like can often be specified. The many computerized reservation systems generally universally operate in this manner. It is desirable that other considerations be included in the travel planning and scheduling process.

### SUMMARY OF THE INVENTION

Embodiments of the present invention generally relate to a method and a website for making travel plans between an originating location and a destination that may be at least partially determined by weather criteria that may exist at the destination during the time period in which a trip is to be made.

### DESCRIPTION OF THE DRAWINGS

FIG. 1 is a block diagram of the major components of the preferred embodiment of the present invention;

FIG. 2 is a window or page of a website illustrating aspects of the selection process of the preferred embodiment;

FIG. 3 is another window illustrating other aspects of the selection process of the preferred embodiment of the present invention;

FIG. 4 is another window illustrating the results of a search process utilizing the choices that were made in the windows of FIGS. 2 and 3;

FIG. 5 is a window illustrating the booking process;

FIG. 6 is a flow chart illustrating the steps of the method of the preferred embodiment of the present invention;

FIG. 7 is a more detailed flow chart of a portion of the CRS search process shown in FIG. 6; and

FIG. 8 is a more detailed flow chart of a portion of the weather search process shown in FIG. 6.

### DETAILED DESCRIPTION

Broadly stated, the preferred embodiment of the method of the present invention and the website that is used to implement the method utilizes one or more computerized reservations systems (CRS) in combination with data sources or databases that provide weather related information. Such weather related information can include weather forecasts at various destinations, as well as averages of weather information for the particular time period of interest from one or several years.

If a traveler is uncertain as to the destination, but knows what he or she would like to do at the destination, such weather related information can be instrumental in the choice of a destination at the time in which the traveler wishes to travel. For example, if an individual wishes to escape to sunshine and warmth, that choice would result in a destination that would be quite different from one who wished to go skiing. The preferred embodiment of the present invention uses weather criteria as a significant factor, if not a major factor in determining destinations of a trip. The preferred embodiment of the method is preferably carried out over the Internet, but large area networks may also be used if appropriate. A website that can be accessed by potential travelers is a desired implementation of the method of the preferred embodiment.

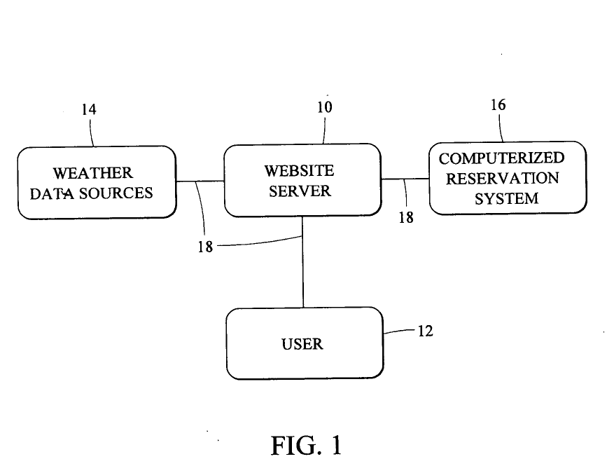

The basic components of the present invention are shown in FIG. 1, and includes a website server, indicated generally at 10, with the server being connected to one or more users 12, as well as to a weather data source 14 and a computerized reservation system or CRS 16, with the connections between these components being made preferably through the Internet 18, although other large area networks could be used. As is known to those who professionally use CRS's, access to multiple CRS's is often made through the use of an application program interface (API) which enables queries to be simultaneously made to several CRS's. An API is an external web service that performs such simultaneous querying of multiple CRS's. The Internet is the preferred interconnection among most of these components because it is a worldwide communication network.

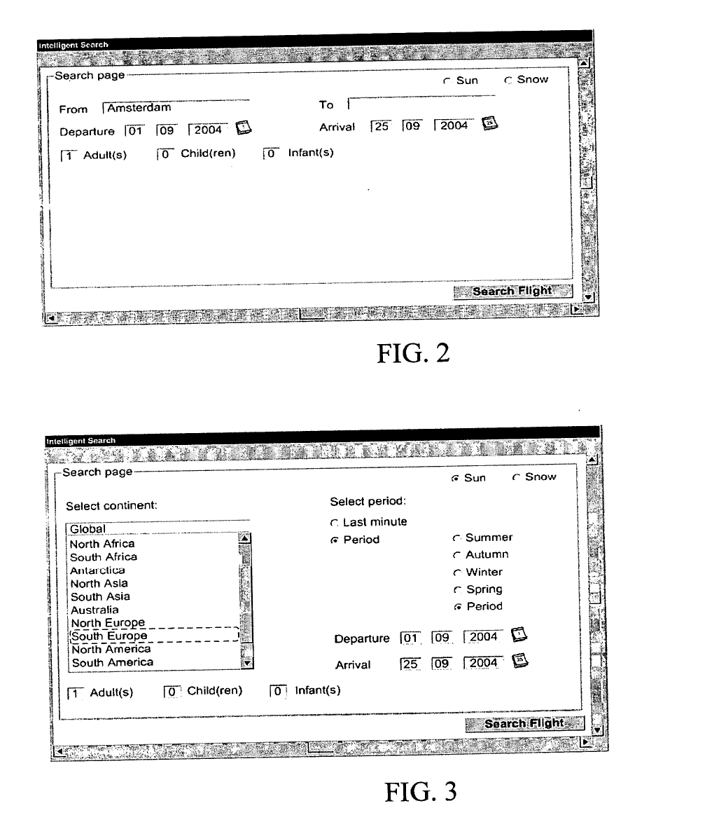

Referring to FIG. 2, a web page or window is shown and comprises a search page which the traveler may use to plan a trip. As is evident, there is an originating location or field which is shown to indicate Amsterdam, and a destination field that is shown to be blank. A departure date is selected by the traveler, indicated as Sep. 1, 2004, and a return (arrival) date of Sep. 25, 2004, is also indicated. Fields indicating the number of adults, children and infants are also illustrated.

Significantly, a choice between sun and snow is presented at the upper right corner of the window which means that the traveler would make the obvious choice between warm beach activity and skiing, for example. A second search screen is shown in FIG. 3, which is more generalized in some respects and more detailed in others. In this window, the traveler can indicate a preference of a geographical region, which in the illustrated embodiment, includes the continents of the world or major portions of some of the continents.

With regard to the time period of travel, unlike the specific departure and return dates shown in FIG. 2, more general periods can be chosen, such as spring, summer, autumn and winter, in addition to a “period” choice, which calls for the insertion of specific dates. A unique additional choice is indicated as “Last minute” which connotes that a traveler wishes to get away soon with very little advance planning. The present invention has even greater appeal for this type of travel planning, for the reason that weather forecasting for the next few days or weeks can be much more accurate, which means that a travel destination can be planned with greater assurance of the weather cooperating with the desired activities that the traveler envisions. Again, if the traveler wishes to lie on the beach in the Mediterranean, destinations can be chosen which more or less assure that the sun will be shining while he or she is there. The use of the previously described geographical regions enables the search to be narrowed in a reasonable manner.

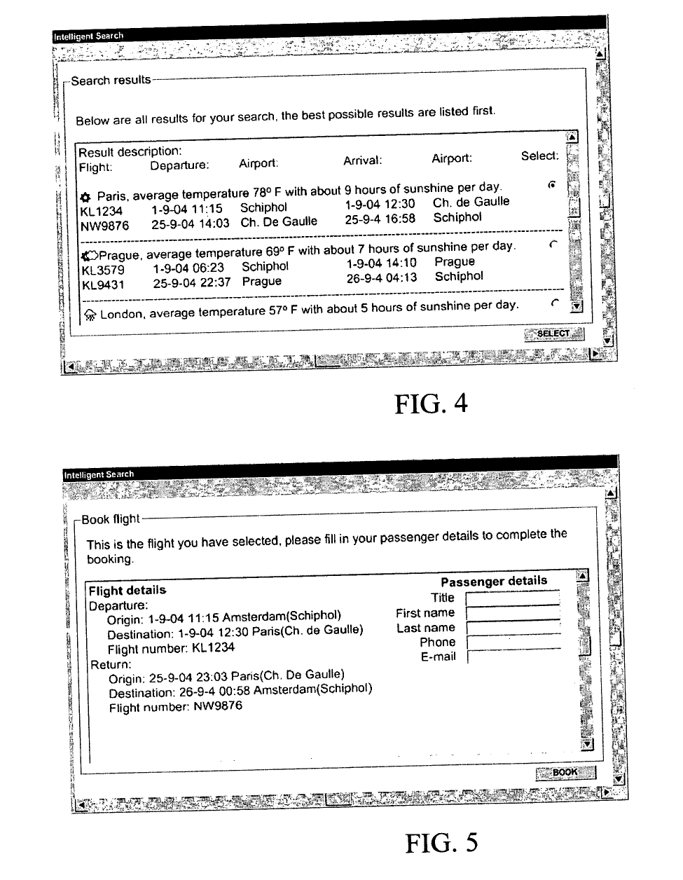

Once the selections are made, the user then clicks the search icon at the lower right hand corner of the windows shown in FIGS. 2 and 3 and the website server then initiates the search for destinations within the chosen geographical area that have the desired weather criteria during the time span that is chosen by the user. The results of the search are displayed in a search result window as shown in FIG. 4, which in the illustrated example lists a flight to Paris from Amsterdam as well as a return flight and the indication that the average temperature is 78° F. with about nine hours of sunshine per day. This for the time period of September 1 through September 25. A similar flight to Prague is listed below the Paris flight, with the various flight choices being displayed.

The user can then select one of the flights and a book flight window than is presented by the website server as shown in FIG. 5 and this window illustrates the flight details and provides fields for the user to fill in personal information such as the person's first and last name, phone number, e-mail and title. After that information is provided, the user can click the book icon at the lower right hand corner of the window to book the flight.

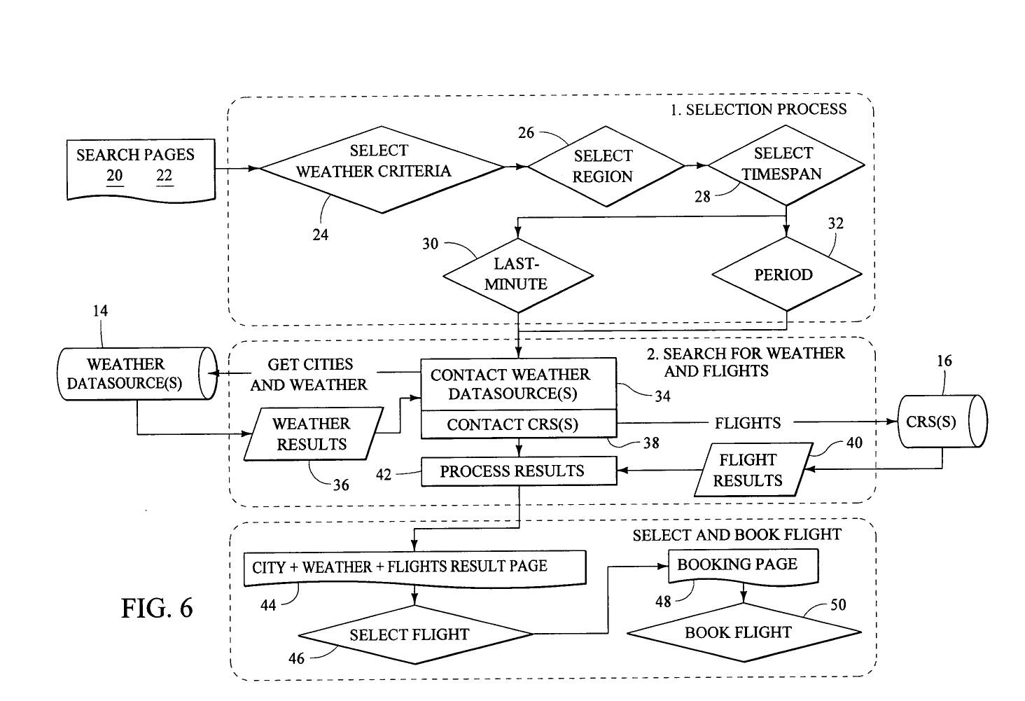

With regard to the operation of the preferred embodiment of the present invention, and referring to the flowchart shown in FIG. 6, the website server has software which produces the various windows shown in FIGS. 2-5 as previously described and also provides the engine for the operation and functionality of the website.

Turning now to FIG. 6, the server generates the search pages or windows 20 and 22 which enables the user to make the various choices that are shown on these search pages. Thus, the user will select weather criteria (block 24) as well as a region (block 26) and also select the time span for the proposed trip which can encompass either the selection of the “last minute” choice (block 30) or a period (block 32) of time that can be general as in the spring, summer, autumn and winter, or specific departure and return dates. Once the selection process is completed by the user, the user presses a search icon in the windows 20 and 22 which causes the website server 10 to search for weather information as well as flight information.

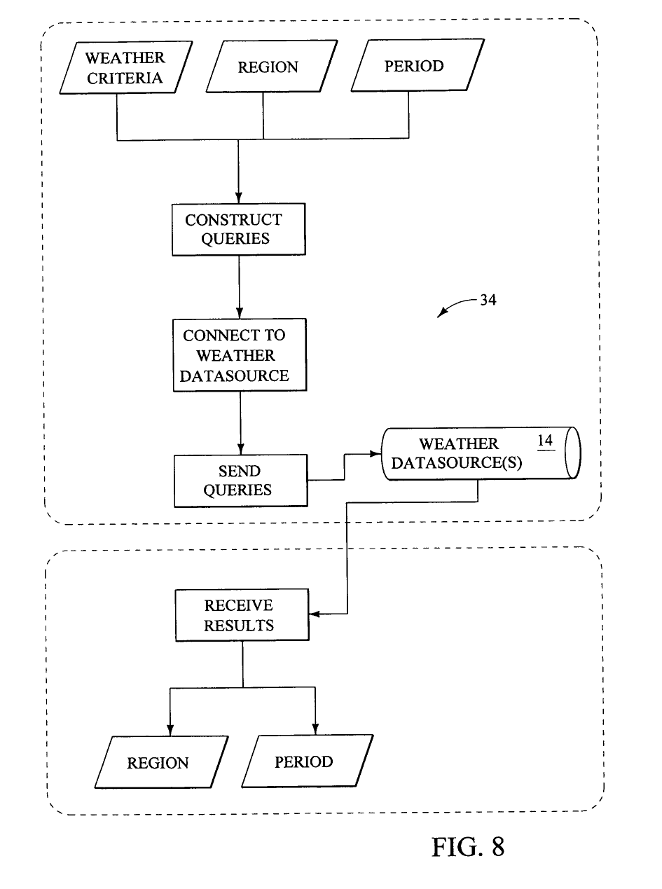

The initial action that is taken is for the server to contact weather data sources (block 34) to yield weather results (block 36). With regard to the contacting weather data sources action, the internal preferred process of the website server is shown in FIG. 8 where the server initially constructs queries based upon the traveler's indicated choices for weather criteria, region and period. The server then sets up connections to one or more weather data sources and sends the queries to the data source to obtain a list of all cities in the geographical region that satisfy the selected weather criteria. The results are then received by the server (block 40).

The weather data sources can be any data source that supplies weather forecast data or historical information that may include weather criteria averages for a particular destination. In this regard, averages of high and low temperatures, amount of rain, wind speed, snowfall, snow accumulation and amount of sunshine and the like may be obtained over one or several years for the desired time span of the trip and depending upon the queries that were constructed, the results of them is returned by the weather data source preferably for each city. Additionally, more current weather conditions or criteria may also be returned. Particularly, the accumulated snow in a skiing area may be very desirable information. Based upon the results of the weather queries, one or several cities in the geographical area may satisfy the weather criteria.

The website server then initiates the action to contact the computerized reservation system (block 38) to obtain flight information for all cities in the region that satisfied the weather criteria for the specified dates. While it may be done many different ways, it is preferred that flight results would be generated based upon some reasonable lead time from the time of the request, i.e., one or two weeks in the future, and have a duration that is commonly scheduled, such as one or two weeks. However, representative results may be returned in many different ways. It may be desirable to require the traveler to specify a narrower range of departure and return dates for a trip. The flight results are returned to the website server (block 40) which processes the results (block 42).

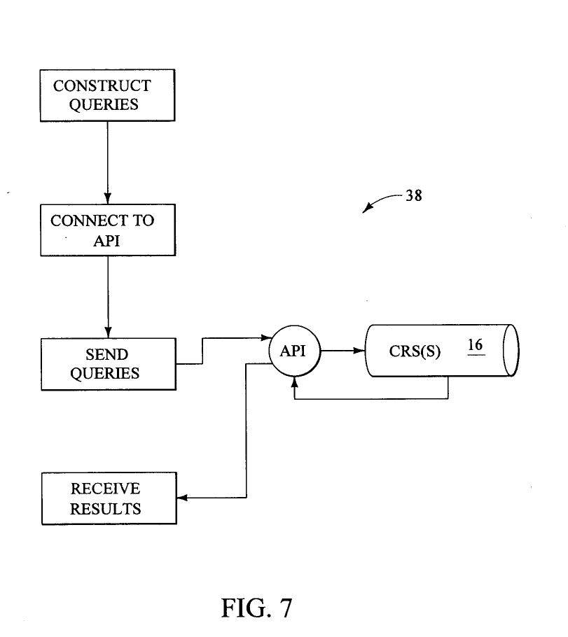

With regard to the contacting of the CRS, there are several systems including the Galileo, Amadeus, Sabre and Worldspan systems that provide airline scheduling information. The preferred internal process is shown in FIG. 7, and begins with the server constructing the necessary queries based on the cities that were returned by the weather data sources. The server then connects to an API which is an external web service that can query multiple computer reservation systems simultaneously and the results of the queries are then received by the server (block 40).

The server then processes the results (block 42) by preferably displaying a list of cities with the matching flights and weather information for them as has been previously described with regard to FIG. 4. The user can then select a flight (block 46) and the completion of that results in the server displaying a booking page (block 48) from which the operator can complete the process and book the flight (block 50).

It should be understood that while the preferred embodiment has been described in connection with flight plans, the method and website is applicable to arranging rail or water travel, or a combination of all of these modes of travel. Similarly, data sources other than weather could be used in combination with CRS's to make travel plans.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the following claims.

What is claimed is:

1. A method of making travel plans from an originating location by searching one or more databases on a network, comprising the steps of:
selecting a time period in which travel is to be taken;
selecting a geographical region in which a possible travel destination is located;
selecting weather criteria for a travel destination;
searching one or more weather related databases to locate possible destinations in said selected region having said selected weather criteria in said selected time period;
searching travel scheduling databases for said located possible destinations to determine at least one travel plan.

2. A method as defined in claim 1 further comprising the step of displaying said at least one travel plan on a monitor.

3. A method as defined in claim 1 wherein said displayed travel plan comprises the identity of a possible destination, the weather forecast for the destination during the travel time period and one or more travel schedules between the originating location and toe possible destination.

4. A method as defined in claim 3 wherein said travel schedules comprise flight information between airports at said originating location and said possible destination.

5. A method as defined in claim 1 wherein said step of selecting weather criteria for a travel destination comprises designating one of at least two weather related choices.

6. A method as defined in claim 5 wherein said weather related choices include at least one selected from the group consisting of sun, snow, hot, calm, windy.

7. A method as defined in claim 5 wherein said step of searching one or more weather related databases comprises:
constructing queries for said selected weather criteria;
connecting to one or more weather forecasting data sources;
sending said queries to said one or more weather forecasting data sources;
receiving city and weather forecasting data identifying one or more cities in said geographical region that match said weather criteria.

8. A method as defined in claim 7 wherein said queries request weather averages during said time period for one or more prior years.

9. A method as defined in claim 8 wherein said weather averages comprise one or more from the group consisting of high and low temperature, amount of rain, wind speed, snowfall, snow accumulation and amount of sunshine.

10. A method as defined in claim 1 wherein said searching travel scheduling databases further comprises contacting one or more computerized reservation systems to locate one or more flight schedules to airports near said possible destinations.

11. A method as defined in claim 10 wherein said step of searching travel scheduling databases further comprises:
constructing queries for said one or more computerized reservation systems;
connecting to said one or more computerized reservation systems; and
sending said queries to said connected computerized reservation systems.

12. A method as defined in claim 11 further comprising receiving flight schedules to said airports near said possible destinations in response to said queries.

13. A method as defined in claim 11 wherein said computerized reservation systems include the Galileo, Amadeus, Sabre and Worldspan systems

14. A method as defined in claim 1 wherein said time period comprises a range of dates in the future.

15. A method as defined in claim 1 wherein said time period comprises the immediate future.

16. A method as defined in claim 1 wherein said network is the Internet.

17. A server for implementing a website for making air travel plans from an originating location to a destination that is at least partially determined by using at least one computerized reservation system together with weather criteria searching on one or more weather related data sources via the Internet, said server implementing said website comprising:
one or more web windows in which a user can:
select a time span in which travel is to be taken;
select a geographical region in which a possible travel destination is located;
select weather criteria for a travel destination;
said server being capable of connecting to and searching one or more weather related data sources to locate possible destinations in said selected geographical region having said selected weather criteria in said selected time period;
said server being capable of connecting to at least one computerized reservation system for said located possible destinations to determine at least one flight schedule;
said server being capable of displaying said possible destinations, said possible flight schedules and information concerning weather conditions at said destination during said travel time span.

18. A website as defined in claim 17 wherein said weather conditions information comprises weather averages during said time period for one or more prior years.

19. A website as defined in claim 18 wherein said weather averages comprise one or more from the group consisting of high and low temperatures, amount of rain, wind speed, snowfall, snow accumulation and amount of sunshine.

20. A website as defined in claim 17 wherein said one or more web windows includes choices relating to selecting said time span, said choices including one or more of the following:
last minute;
spring;
summer;
fall;
winter; and
period, wherein said period fields include a month, date and year of departure and month, date and year of return.

21. A website as defined in claim 17 wherein said web windows include fields in which a user can specify the number and relative ages of travelers and can make reservations on selected flights.

22. A website as defined in claim 17 wherein said one or more web windows include choices relating to weather criteria, such as sun or snow.
